(19) United States
(12) Patent Application Publication
(10) Pub. No.: US 2002/0160812 A1
(43) Pub. Date: Oct. 31, 2002

(54) Channel supervision in a radio network

(76) Inventors: Ramin Moshiri-Tafreshi, Bonita, CA (US); Alfiya Vali-Durrett, San Diego, CA (US)

Correspondence Address: COATS & BENNETT, PLLC, P O BOX 5, RALEIGH, NC, 27602, US

(21) Appl. No.: 09/843,232

(22) Filed: Apr. 26, 2001

(51) Int. Cl. H04Q 7/20

(52) U.S. Cl. 455/561; 455/452; 455/450; 455/514

(57) ABSTRACT

A wireless communication network uses multiple timers to selectively free communication resources dedicated to supporting a packet data connection with a wireless access terminal. If the connection remains inactive for longer than a first time-out period, the network releases a portion of the RF resources dedicated to the connection, thereby making these resources available for supporting other connections. If the connection remains inactive for longer than a second time-out period, the network releases the remaining RF resources, as well as releasing other communication resources in the network dedicated to supporting the connection. By avoiding call tear down until expiration of the second time-out period, the network maximizes availability of its RF resources, without significantly increasing call signaling overhead as would happen with repeated premature tear down of the connection.

### BACKGROUND OF THE INVENTION

The present invention relates to wireless communication networks in general, and more particularly, to a channel supervision method used in a base station controller to more efficiently utilize network resources.

Wireless communication services are, for many people, an integral part of everyday life. An increasing number of users expect their wireless devices and supporting radio networks to provide ready, useful access to an increasingly rich array of information services. Wireless connection with the Internet illustrates a primary example of the trend toward providing a broad range of increasingly sophisticated communication services.

Many communication protocols, such as IS-95 and IS-2000, support both voice communications and packet data services. In the current state of the art, when an access terminal establishes a packet data session with the radio network, the radio network allocates a fundamental channel and, depending on the data rate, also allocates a supplemental channel to the access terminal. The fundamental channel is used primarily for voice traffic and other low data rate services, while the supplemental channel is used for high rate packet data delivery. The allocation of two separate channels to the access terminal consumes scarce network and radio resources despite the fact that the access terminal may use those resources for only a fraction of the time that the packet data session is active.

Typically, a packet data session (e.g., a Web browsing session) will involve relatively short periods of activity during which data is transferred between the access terminal and the radio network separated by relatively longer periods of inactivity. For example, a user browsing the Internet may download a web page. While the web page is downloaded, data is transferred on the downlink to the access terminal. After the download is completed, the user may spend some time reading or viewing the contents of the web page. While the user is viewing the web page, the packet data connection will be inactive. Nevertheless, the channel is reserved for the user so that other users may be blocked from the radio network.

One method used in the past of freeing up some network resources for both fundamental and supplemental channels is to use an inactivity timer to monitor the activity status of a packet data connection. The network resources dedicated to that connection are released if the access terminal remains inactive for a period that exceeds the duration of the inactivity timer. Those resources, both radio and network, can then be allocated to another access terminal. The first access terminal must then re-establish a connection with the radio network to continue receiving packet data services. This method increases the utilization of the radio network at the cost of greater signaling overhead, which burdens the base station controller. If the duration of the inactivity timer is too short, the increased signaling may exceed the capacity of the call-processing stack, which would reduce the number of subscribers supported per base station controller and is therefore undesirable. Conversely, increasing the duration of the inactivity timer to decrease signaling overhead reduces radio and backhaul utilization, which is also undesirable to the service provider. Therefore, system operators are currently faced with trading off between achieving greater radio and backhaul utilization or decreasing signaling overhead.

### SUMMARY OF THE INVENTION

The present invention is a method of implementing two or more timers in a radio network to more efficiently utilize network and radio resources, particularly the radio frequency channels used by the access terminal to communicate with the base station. A base station controller allocates a fundamental radio frequency channel and, based on the data rate, may also allocate a supplemental radio frequency channel to the access terminal to establish a packet data connection. Resources within the base station controller are also allocated to support the packet data connection. Once the packet data connection is established, the base station controller uses two inactivity timers to monitor the activity status of the packet data connection. One timer has a relatively short duration and the other timer has a relatively longer duration. The timers are reset each time activity is detected.

The timer with the shorter duration is used to control release of the supplemental channel and the associated backhaul resources. The timer with the longer duration is used to control release of the fundamental channel and other network resources supporting the packet data connection. If the packet data connection is inactive for a period that exceeds the duration of the short timer, the base station controller releases the supplemental channel but the fundamental channel and other network resources are maintained. If the access terminal resumes communication on the fundamental channel before the long timer expires, a new supplemental channel is re-allocated to that access terminal if needed. Thus, the supplemental channel may be dynamically allocated while the packet data session is active. If the access terminal remains inactive for a period that exceeds the duration of the long timer, then the fundamental channel and all other network resources are released. After the network resources are released, the access terminal must establish a completely new connection to continue receiving packet data services.

### BRIEF DESCRIPTION OF THE DRAWINGS

FIG. 1 is a diagram of an exemplary service provider network in which aspects of the present invention may be practiced.

FIG. 2 is a diagram of exemplary flow logic for connection supervision in accordance with the present invention.

FIG. 3 is a flow diagram of forward and reverse supplemental channel set up in an IS-2000 base station controller.

FIG. 4 is a flow diagram of forward supplemental channel release.

FIG. 5 is a flow diagram of reverse supplemental channel release.

### DETAILED DESCRIPTION OF THE INVENTION

Referring now to the drawings, the channel supervision method of the present invention is shown in the context of an IS-2000 service provider network, which is indicated generally by the numeral 10. IS-2000 is a communications protocol for next generation Code Division Multiple Access (CDMA) radio networks published by the Telecommunications Industry Association (TIA) and the Electronics Industry Association (EIA). Those skilled in the art will recognize, however, that the channel supervision may also be used with networks that conform to other communication protocols and standards such as IS-95 and Wideband CMDA (W-CDMA) systems.

The service provider network 10 provides wireless communication services to a plurality of wireless access terminals 12. More particularly, the service provider network 10 provides a means for access terminals 12 to connect with the public Switched Telephone Network (PSTN) 14, the Internet or other Packet Data Networks (PDNs) 16. The network 10 typically comprises a radio access network (RAN) 11, which comprises a plurality of radio base stations (RBSs) 20, and one or more base station controllers (BSCs) 22. The network 10 further comprises one or more mobile switching centers (MSCs) 24, and one or more packet data serving nodes (PDSNs) 26.

The RBSs 20 communicate over RF channels with the access terminals 12 and serve as an access point for access terminals 12 desiring connection with the service provider network 10. A given RBS 20 provides service to a geographic region referred to as a sector or cell. Typically, there is one RBS 20 in each sector or cell, which provides service to all access terminals 12 within the sector or cell.

Each RBS 20 connects via a communications link, such as a T1 or E1 link, to the BSC 22, which in turn connects to the MSC 24 and to the PDSN 26. BSC 22 handles resource allocation and call set-up for a plurality of RBSs 20. The BSC 22 interfaces with the MSC 24 and with the PDSN 26. The BSC 22 includes a Packet Core Function (PCF) to manage its connection with the PDSN 26. For example, the BSC 22 may include a dedicated Asynchronous Transfer Mode (ATM) interface supporting packet data communication and control between it and the PDN 16 via the PDSN 26.

When an access terminal 12 sends a connection request, the connection request is received by the BSC 22, which then communicates with the MSC 24 to allocate resources (call setup) on the A2/A5 interface for circuit-switched services. The MSC 24 communicates with the home location register (HLR) 28 for authorization and mobility management information. For a non-packet data call, the BSC 22 cooperates with the MSC 24 in performing call set up. It typically uses a System Signaling 7 (SS7) signaling protocol during call set up operations conducted with the MSC 24. Generally, the BSC 22 maintains a call-processing stack, sometimes referred to as an SS7 stack, in which the various parameters and information supporting call management are maintained. A certain amount of call processing overhead is incurred in the BSC 22 for each call that it manages. The MSC 24 establishes a connection with the PSTN 14, thus providing access to the PSTN 14 to the subscriber placing the call via the access terminal 12.

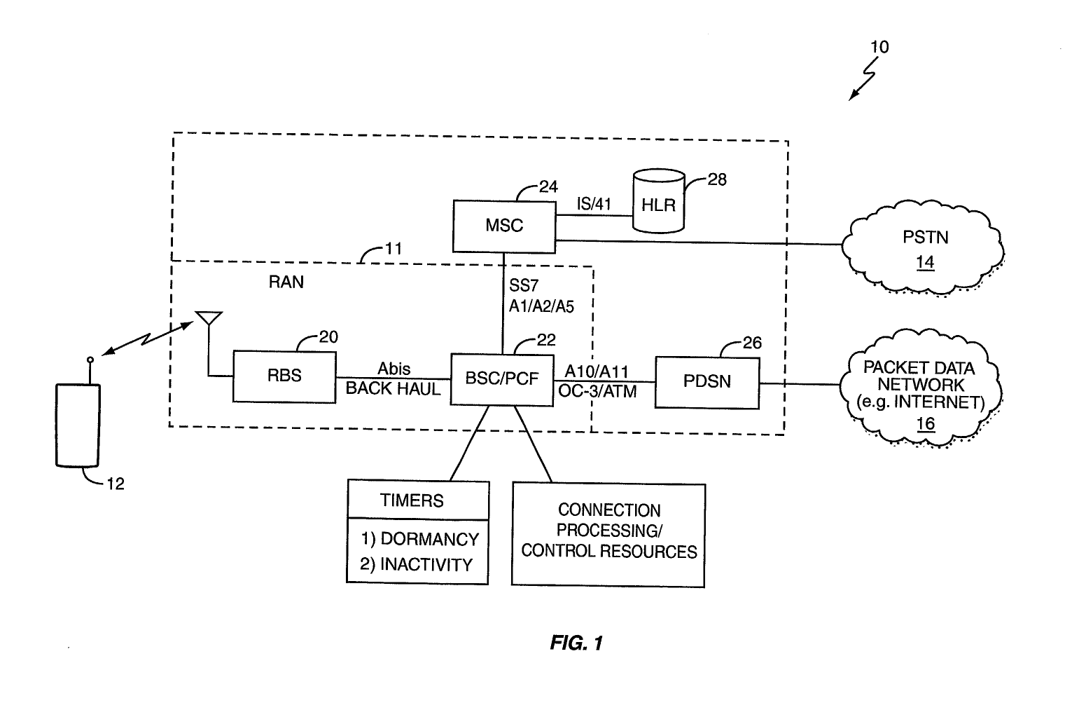

When establishing a packet data call, the BSC 22 performs much the same processing as above, including authorization and call set up procedures requiring communication with the MSC 22 and HLR 28. However, rather than establishing a connection with the PSTN 14 via the MSC 24 and allocating A2/A5 resources, the BSC 22 establishes a packet data connection with the PDSN 26 shown in FIG. 1.

While a number of parameters determine overall capacity of the service provider network 10, the availability of RF resources in the RBSs 20 and the call processing capacity of the BSC 22 are both significant. Oftentimes, RF resources are critical as only a limited number of RF signaling resources are available in any given RBS 20. Such resources include, for example, the demodulation circuitry in an RBS 20 that is assigned to a given access terminal 12. There is substantial impetus to free up RF resources assigned to a given access terminal 12 as quickly as possible in the interest of making them available for use by another subscriber desiring connection with the radio access network 11.

As the sophistication of connection services offered via the radio access network 11 increases, subscribers potentially consume an even greater amount of RF resources and the efficient supervision of RF resource allocation becomes an even more acute problem. For example, in the IS-2000 service provider network 10 illustrated, a subscriber desiring a high-speed packet data connection is allocated both a fundamental channel, as well as a higher bandwidth supplemental channel. As packet data services evolve, it is expected that a single subscriber may be assigned multiple high bandwidth channels to support simultaneous packet data connections, along with simultaneous voice communication.

Further exacerbating the problem, packet data connections are subject to relatively long idle periods, during which the RF resources allocated to the connection are not used. To more fully appreciate this, one must consider the nature of web browsing, which represents typical packet data connection usage. In web browsing, the subscriber enters an Internet address or destination, which the access terminal 12 communicates to the service provider network 10, which in turn accesses the corresponding Internet server. The web page or site information is then returned from the server to the access terminal 12 via the service provider network 10. Typically, the subscriber spends a few seconds to several minutes reviewing the received information before initiating another transfer. This usage pattern results in relatively long idle periods during which the assigned RF resources are essentially “wasted.” Ideally, the service provider network 10 would free all of the RF resources allocated to a connection that has been idle longer than a defined limit. However, completely tearing down the connection prematurely exacts a call-processing penalty on the network 10, which can ultimately reduce the number of subscribers it supports. For example, assume that the network 10 is configured to completely release a packet data connection if the connection remains idle longer than thirty seconds. It may be that the subscriber associated with the connection is engaged in a typical download-and-browse type web session and will intermittently request new data. Thus, the network 10 is left to repeatedly set up and tear down the call owing to repeated expirations of the maximum allowed idle period.

The present invention provides multiple timers for selectively releasing resources in the service provider network 10 as a function of access terminal inactivity. In an exemplary embodiment, the BSC 22 maintains first and second timers for packet data connections.

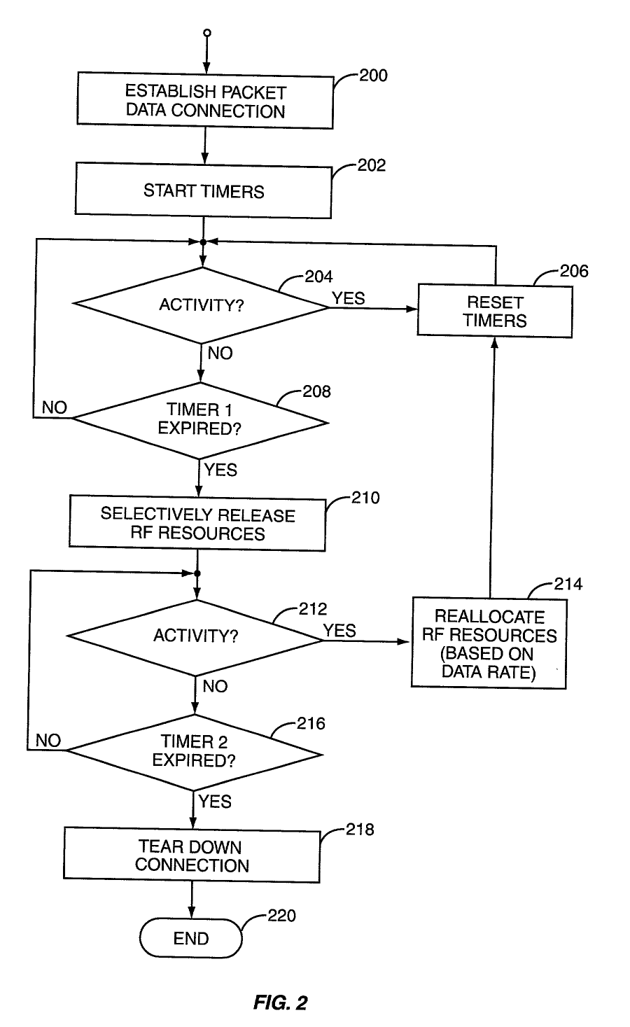

FIG. 2 is a diagram of exemplary packet data connection supervision logic for a given packet data connection. The service provider network 10 establishes a packet data connection with a requesting access terminal 12 (block 200). A supervising element within the network 10 begins timing the connection using first and second timers (block 202). Typically, the BSC 22 serves as the supervising element, given its principal role in network resource allocation, including RF resource allocation in the supporting RBS 20, and in consideration of its call set up and tear down processing in association with the MSC 24. In some cases, the first timer may be considered a short duration “inactivity” timer, while the second timer may be considered a longer duration “dormancy” timer.

When connection activity is detected (block 204), the BSC 22 resets the timers and continues monitoring for activity (block 206). It should be understood that the logic flow focuses on inactivity timing for clarity and omits substantial complexity associated with actually managing the connection. Thus, the BSC 22 performs numerous other communication processing and supervisory functions concurrent with the illustrated operations.

If no connection activity is detected, the BSC 22 determines if the shorter =duration timer (timer 1) has expired (block 208). If the first time out period has expired, the BSC 22 releases at least some of the RF resources associated with the connection, making the released RF resources available for supporting other connections (block 210). In the IS-2000 service provider network 10, the released RF resources comprise those resources dedicated to the supplemental channel, which provides the subscriber with additional bandwidth, typically greater than 14.4 kbps and up to 144 kbps, in support of the packet data connection. The BSC 22 retains the fundamental channel for the subscriber, which is typically associated with voice and certain data communications.

In other types of radio networks, the subscriber may be dynamically allocated varying amounts of RF/communication bandwidth based on his or her level of activity, or on the type of data being transferred through the corresponding packet data connection. In this type of environment, the BSC 22 or other supervisory element could reduce allocated bandwidth upon expiration of the first timer.

Despite releasing selected RF resources (supplemental channel and associated backhaul resources) that are more scarce, the BSC 22 maintains the call set up for the connection, which means that it does not de-allocate remaining network resources used to support the connection, or tear down the call via signaling with the MSC 24. In this manner, the BSC 22 avoids prematurely engaging in call tear down or resource releasing activities.

After selectively releasing RF resources, the BSC 22 continues monitoring for activity (block 212). If no activity is detected, the BSC 22 determines if the second time out period (timer 2) has expired (block 216). If so, the BSC 22 releases performs full call tear down procedures, which releases remaining RF and network resources, including internal call management and processing resources at the BSC 22 (block 218). From the perspective of this simplified flow, processing then ends (block 220).

Note that the BSC 22 may not completely clear the connection in that it may maintain selected indicators and internal processing resources for some time after expiration of the second timer. For example, the BSC 22 may maintain a reserved communication channel on its interface with the PDSN 26 for an additional length of time. This may offer advantages in that the PDSN interface is typically not resource starved and there is still some likelihood that the subscriber will resume packet data communication with network 10.

If high data rate activity is detected on the connection after expiration of the first timer but before expiration of the second timer (block 212), the BSC 22 optionally reallocates supplemental RF resources to the access terminall4 based on required data rate (block 214), and resets both timers (block 206). At that point, subsequent processing is as described above. Note that communication between the network 10 and the access terminal 12 after release of the supplemental channel RF resources will typically use the fundamental channel RF resources left dedicated to the access terminal 12. This would generally hold true until the network 10 was able to re-allocate supplemental channel RF resources to the access terminal 14 in light of its resumed high data rate activity.

The relative limitations of RF resource capacity and call processing performance for a given service provider network 10 play a role in determining optimal values for the first and second timers. Overly long or short settings for either or both timers will reduce the advantages gained by using multiple time out periods. In some applications, it has been determined that settings of one second and fifty seconds for the first and second timers, respectively, yield significant improvements in the number of subscribers that on average may be supported by the network 10.

In other implementations, the specific performance limitations or advantages will suggest different settings. It is expected that setting the first time out period within the range of one to ten seconds and the second time out period within the range of forty to seventy seconds will cover a range of applications. The relative ease with which the present invention may be incorporated into a service provider network 10 allows empirical determination of the values best suited to a given application. Indeed, the time out values used may change as the network environment changes or grows.

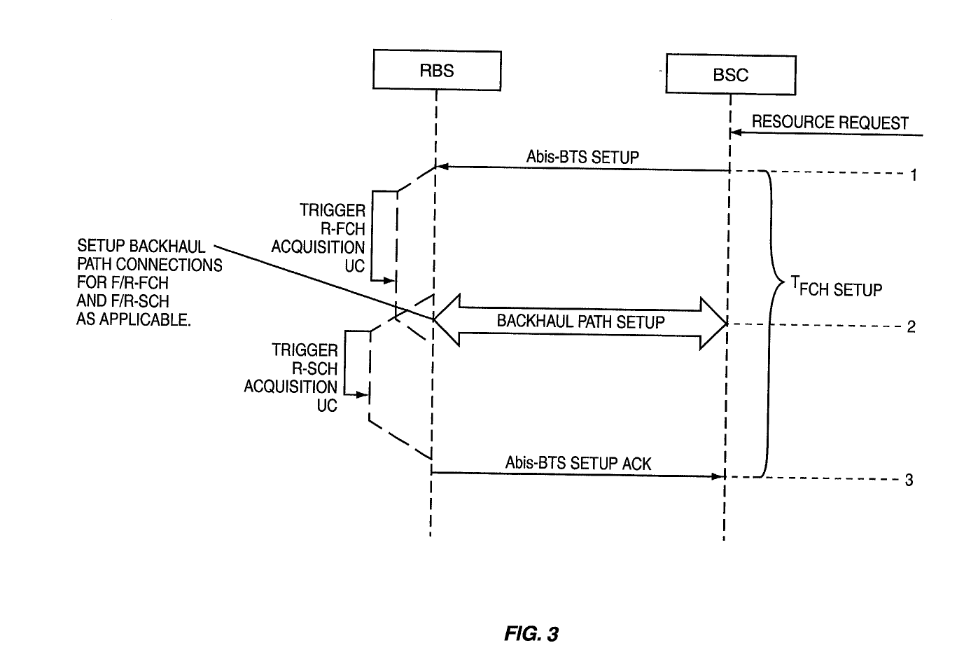

By way of providing more specific details underlying the general processing flow presented in FIG. 2, FIGS. 3-5 provide details for exemplary channel set up and supervision operations for the service provider network 10. Note that the following examples embody particular network arrangements for the BSC 22 and RBSs 20, and are based on specific functions residing within each of those elements. The BSC 22 also includes internal records and other connection management data identifying the specific resource assignments allocated or reserved for each connection it is supporting. Other system designs for the network 10 may have a different functional arrangement and a different sequence of operations associated with allocating and releasing RF and other network resources.

FIG. 3 is a flow diagram detailing set up of the forward and reverse link supplemental channels (F/R-SCH) between the network 10 and an access terminal 12.

In FIG. 3, the BSC 22 sets up radio resources for forward and reverse fundamental channels (F/R-FCHs) and F-SCHs, and/or R-SCHs, on one or more RBSs 20. The BSC 22 times these operations using a forward channel set up timer T_{FCHSetup}.

At (1), the BSC 22 forms an A_{bis}-BTS Setup message for base station transceiver (BTS) setup, and sends it to the RBS 20. On receipt of this message, the RBS 20 selects channel elements for the physical channels indicated in the message. These physical channels can be F/R-FCH, F-SCH and/or R-SCH. Alternatively, for a single FCH or SCH setup, the procedure would be identical. It also indicates to the BSC 22 that backhaul path connections need to be established for the channels to be set up.

At (2), backhaul path connections are set up for the F/R-FCH between the channel element and the BSC 22. Backhaul path connections are also set up for the FSCH and/or R-SCH.

At (3), which is after completion of the backhaul path setup, the RBS 20 sends an A_{bis}-BTS Setup Ack message to the BSC 22 acknowledging the A_{bis}-BTS Setup message, and indicating the successful set up. After the requested links have been set up, the timer T_{FCHSetup} is disabled.

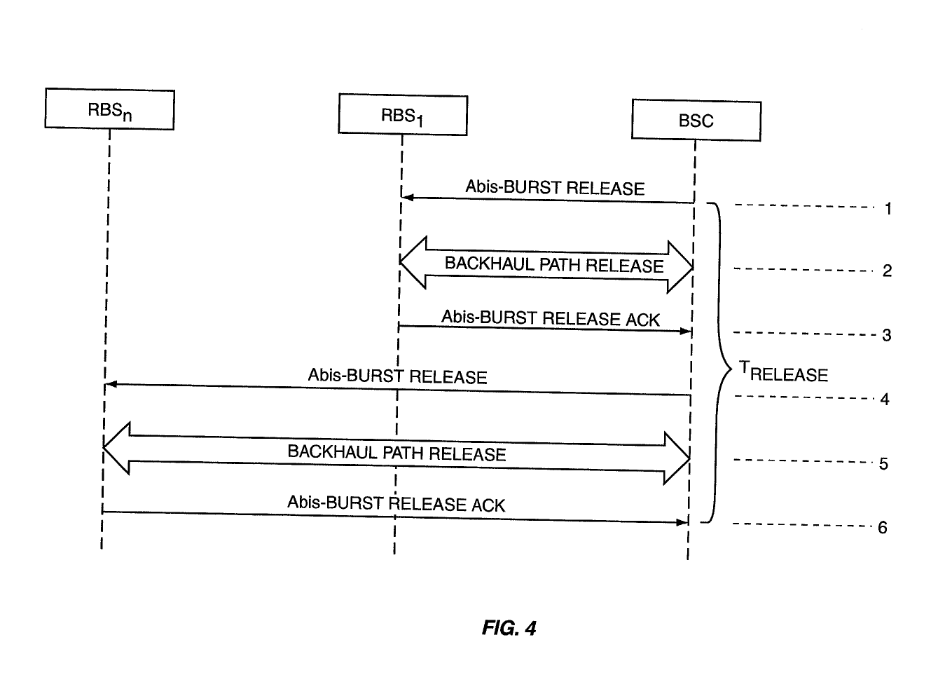

FIG. 4 illustrates how the network 10, and the BSC 22 in particular, releases the F-SCH assigned to one or more access terminals 12. The BSC 22 releases radio resources on one or more RBSs 20. The BSC 22 times these operations using a resource release timer T_{Release}. Note that this timer is used to keep track of resource releases and whether the appropriate release acknowledgements are received at the BSC 22 by the various releasing elements, and is generally not the inactivity or dormancy timers (timer 1 and timer 2) discussed in the flow of FIG. 2.

Steps (1-6) occur in parallel for as many RBSs 20 as the Resource Release Request message has listed.

At (1) the BSC 22 forms an A_{bis}-Burst Release message, and sends it to a first RBS 20. On receipt of this message, the RBS 20 releases the channel element in use and resources associated with it.

At (2), the backhaul path connection for the F-SCH between the channel element and the first BSC 22 is released.

At (3), after tearing down the backhaul path connection and releasing the channel element, the first RBS 20 sends an A_{bis}-Burst Release Ack message to the BSC 22 acknowledging the A_{bis}-Burst Release message, and indicating the successful release.

At (4), the same procedures are carried out as in (1), but for the nth RBS 20.

At (5), the same procedures are carried out as in (2), but for the nth RBS 20.

At (6), the same procedures are carried out as in (3), but for the nth RBS 20.

After the requested links have been released at all the “n” RBSs 20, the BSC 22 determines that all the links have been released and disables the timer T_{Release}.

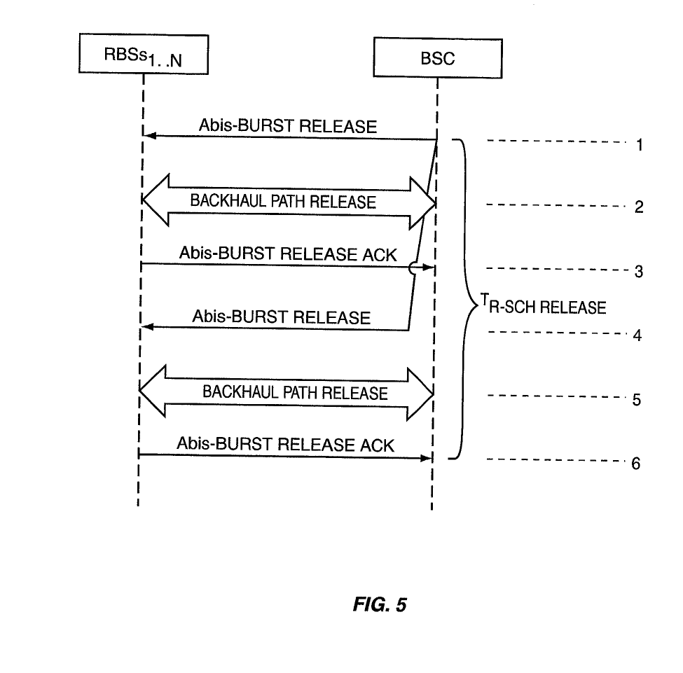

FIG. 5 illustrates flow logic for releasing the R-SCH. At (1), the BSC 22 attempts to release radio resources on one or more RBSs 20, and times these operations using a timer T_{RSCHRelease}. Steps (1-3) occur in parallel for as many RBSs 20 as the Resource Release Request message has listed.

At (1), the BSC 22 forms an A_{bis}-Burst Release message, and sends it to one or more RBSs 20. On receipt of this message, the first RBS 20 releases the channel element in use and resources associated with it. It also indicates to the BSC 22 that the backhaul path connection needs to be released.

At (2), the backhaul path connection for the R-SCH between the channel element and the BSC 22 is released.

At (3), after tearing down the backhaul path connection and releasing the channel element, the first RBS 20 sends an A_{bis}-Burst Release Ack message to the BSC 22 acknowledging the A_{bis}-Burst Release message, and indicating the successful release.

At (4), the same procedures are carried out at the nth RBS 20 as detailed in (2).

At (5), the same procedures are carried out at the nth RBS 20 as detailed in (3).

At (6), the same procedures are carried out at the nth RBS 20 as detailed in (4).

After the requested links have been released at all the “n” RBSs 20, the BSC 22 determines that all the links have been released and the timer T_{RSCHRelease} is disabled.

The present invention may, of course, be carried out in other specific ways than those herein set forth without departing from the spirit and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of managing network resources in a radio network comprising:
establishing a packet data connection with an access terminal;
allocating network resources to said packet data connection with said access terminal, said network resources including a fundamental radio frequency channel and a supplemental radio frequency channel;
monitoring the activity status of said packet data connection using first and second timers, said second timer having a duration value longer than said first timer;
releasing said supplemental channel if said packet data connection is inactive for a period that exceeds said duration value of said first timer while maintaining said connection with said fundamental frequency channel; and
releasing said fundamental frequency channel if said packet data connection is inactive for a period that exceeds said duration value of said second timer.

2. The method of claim 1 further comprising allocating base station controller resources to said packet data connection.

3. The method of claim 2 further comprising maintaining said base station controller resources after expiration of said first timer.

4. The method of claim 3 further comprising initiating call tear-down procedures to release said base station controller resources when said second timer expires.

5. A base station for a radio network comprising:
a base transceiver station for communicating with an access terminal over a fundamental frequency channel and a supplemental frequency channel;
a base station controller to perform channel allocation and supervision, said base station controller having first and second timers and programmed to:
allocate said fundamental radio frequency channel and said supplemental radio frequency channel to said access terminal to establish or maintain a packet data connection with said access terminal;
monitor the activity status of said packet data connection using said first and second timers, said second timer having a duration value longer than said first timer;
release said supplemental channel if said packet data connection is inactive for a period that exceeds said duration value of said first timer while maintaining said connection with said fundamental frequency channel; and
release said fundamental frequency channel if said packet data connection is inactive for a period that exceeds said duration value of said second timer.

6. The base station of claim 5 wherein said base station controller is further programmed to allocate base station controller resources to support said packet data connection.

7. The base station of claim 6 wherein said base station controller is further programmed to maintain said base station controller resources after expiration of said first timer.

8. The base station of claim 7 wherein said base station controller is further programmed to release said base station controller resources after expiration of said second timer.

9. A method of connection supervision in a radio network, the method comprising:
allocating resources to a connection between the radio network and a wireless access terminal in response to receiving a request from the wireless access terminal, said resources including RF resources and base station controller (BSC) resources;
releasing a portion of the RF resources allocated to the connection if the connection remains inactive for longer than a first time out period; and
releasing a remaining portion of RF resources and said BSC resources if the connection remains inactive for longer than a second time out period, said second time out period greater than said first time out period.

10. The method of claim 9 wherein releasing a portion of the RF resources allocated to the connection if the connection remains inactive for longer than a first time out period comprises de-allocating at least one RF channel allocated to said connection at a radio base station in said radio network.

11. The method of claim 9 wherein releasing a portion of the RF resources allocated to the connection if the connection remains inactive for longer than a first time out period comprises reducing the RF bandwidth allocated to said connection.

12. The method of claim 9 wherein said BSC resources connection processing resources in said BSC that are allocated to supporting said connection, and wherein releasing a remaining portion of RF resources and said connection processing resources if the connection remains inactive for longer than a second time out period comprises initiating call tear-down procedures to de-allocate said connection processing resources and said remaining portion of RF resources.

13. The method of claim 9 further comprising setting the relative duration of said first and second time out periods to maximize the number of connections that can be supported by said radio network on average based on a relationship between RF resource capacity of said radio network and connection processing capacity of said radio network.
